(19) United States
(12) Patent Application Publication
(10) Pub. No.: US 2026/0065520 A1
(43) Pub. Date: Mar. 5, 2026

(54) METHOD AND DEVICE FOR GENERATING A RENDERED VIDEO STREAM, IN SOME CASES FOR A LIVE TRANSMISSION

(71) Applicant: Red Bull GmbH, Fuschl am See (AT)

(72) Inventors: Stefan Bonecker, Bergheim (AT); Fangliang He, Salzburg (AT); Alexander Doerr, Bad Toelz (DE); Florian Maxl, Oberalm (AT); Oliver Grimm, Munich (DE); Simon Drexler, Hoerbach (DE); Mathias Sonnleitner, Vienna (AT)

(21) Appl. No.: 18/827,393

(22) Filed: Sep. 6, 2024

(30) Foreign Application Priority Data
Aug. 30, 2024 (EP) 24197528.3

(51) Int. Cl. G06T 11/00; H04N 21/2187; H04N 21/81

(52) U.S. Cl. CPC G06T 11/00; H04N 21/2187; H04N 21/816

(57) ABSTRACT

The present disclosure relates to a method for generating a rendered video stream, in some cases for a live transmission. Furthermore, the present disclosure relates to a device, in some cases a processor, for generating a rendered video stream as well as a computer program product comprising instructions which, when the program is executed by a data processing device, cause the device to carry out the steps of the method according to the present disclosure. Furthermore, the present disclosure relates to a computer-readable storage medium comprising instructions which, when executed by a computer, cause the computer to carry out the steps of the method according to the present disclosure, as well as a system for generating a rendered video stream, comprising the device according to the present disclosure.

### BACKGROUND

### Technical Field

The present disclosure relates to a method for generating a rendered video stream, in some cases for a live transmission, a device for generating a rendered video stream, in some cases for a live transmission, and a system for generating a rendered video stream, in some cases for a live transmission, as well as a corresponding computer program product and a computer-readable storage medium.

### Description of the Related Art

During a live transmission, sound and/or image recordings are transmitted in real time or nearly real time, respectively, to end users, without being previously recorded and permanently stored. In this case, a video stream with a plurality of consecutive images is forwarded directly from the image capturing device to a transmission center, which forwards the video stream directly to the end users, for example by integration into a television program or uploading to a platform.

During a live transmission, it is desirable to display objects such as objects or persons in a suitable surrounding during the transmission. For this purpose, the objects can be positioned directly in the corresponding surrounding. However, this is usually complex; for example, corresponding studio equipment must be made available on site.

Therefore, the objects are often positioned in a specially set-up studio environment in a building. The objects are recorded in the studio by way of an image capturing device such as a camera, which records the video stream in the studio environment and forwards the recorded video stream directly to the transmission center. In addition, the video stream can be adapted and post-processed in the transmission center. Depending on the buffer memory available and the bandwidth, the individual images of the video stream can be sent to the transmission center individually at consecutive points in time corresponding to the recording time of the individual images or in groups in real time.

In some cases in the further use of the recorded and possibly post-processed video stream, for example for television or advertising clips, a high quality of the recordings and of the post-processing is desirable. During the recording and post-processing of such a video stream, larger amounts of data are usually obtained, which must be processed in some cases in real time. One advantage of a studio environment is that high-performance equipment can be pre-installed, which makes it possible to record high-quality images, to process the corresponding amounts of data and to provide the necessary bandwidths for transmission. In addition, the ambient conditions, such as, for example, the illumination of the objects by headlights or a recorded sound quality by the choice of microphones, can be set in a studio environment.

In addition, the surrounding of the recorded objects can be modeled within the studio. In recent years, the technologies for cut out objects in the studio environment have been developed. For this purpose, the objects are imaged in front of a background kept in a uniform green shade. The green background can be isolated from the objects located in front of it by way of post-processing the video stream and can be replaced by another background. In the transmission in such a video stream, it is in some cases important that the object is inserted into the surrounding as realistically as possible. The green shade of the background has proven advantageous in this case, since conventional objects can be isolated from the green background very efficiently by the available software. The calculation steps necessary for this can be implemented in a high-quality manner by the high-performance components which can be used in the studio environment and conventional software, with the result that the replacement of the background can be identified only with difficulty for a viewer, if at all, in the live transmission.

The replaced background is essentially freely selectable in this case, and a large number of existing backgrounds stored in digital form can be resorted to. As a result, it is possible to reproduce objects from the studio realistically in a video stream in a freely selectable digital surrounding.

However, the previous approaches for generating such a video stream have proven to be insufficiently flexible. Thus, a spatial studio environment is not suitable for every object. In addition, the setting up of a studio is complex and cost-intensive, in some cases if updates or adaptations have to be undertaken on a topic-dependent basis.

Thus there is accordingly a need, to improve the previous approaches for generating a video stream for a live transmission, in some cases to provide a method for generating a video stream, in some other cases for live transmissions, which can be used flexibly and can be implemented as cost-effectively as possible.

### BRIEF SUMMARY

Accordingly, a method for generating a rendered video stream, in some cases for a live transmission, has been found. The method according to the present disclosure comprises the following steps performed by a processor: receiving a video stream with a multiplicity of real surrounding images, for example from an image recording unit; and receiving raw data from at least one virtual object, for example from an external server. Furthermore, the method comprises the steps performed by the processor for a first real surrounding image of the multiplicity of surrounding images: generating rendering data for the at least one virtual object, rendering the at least one virtual object based on the raw data and the rendering data, and generating a rendered first image by inserting the at least one rendered virtual object into the first real surrounding image. The rendered first image is output in the rendered video stream comprising a plurality of rendered images. The rendered video stream can be output, for example, to an external entity, such as a transmission center, in some cases directly. In expedient embodiments, the rendered video stream can be output via an NDI connection.

Using the method according to the present disclosure, a virtual object can be inserted into a real recorded surrounding image in a video stream for a live transmission, instead of digitally replacing the background to form a really recorded object. The method according to the present disclosure can thus be used flexibly and in a versatile manner. The surrounding images of the video stream can be recorded on site, and any desired virtual objects can be inserted into the real surrounding images. The method according to the present disclosure is thus no longer subject to the previous restrictions of a studio, in some cases also not to the spatial restrictions of a studio.

### BRIEF DESCRIPTION OF THE SEVERAL VIEWS OF THE DRAWINGS

Further details and advantages of the present disclosure are described in more detail with reference to the figures mentioned below.

FIG. 1 shows by way of example a system for generating a rendered video stream for a live transmission in a first embodiment.

FIG. 2 shows by way of example a system for generating for generating a rendered video stream for a live transmission in a further embodiment.

FIG. 3 shows by way of example an image from a rendered video stream.

FIG. 4 shows by way of example a sequence of steps for a method for generating a rendered video stream for a live transmission.

### DETAILED DESCRIPTION

The method according to the present disclosure can be carried out on conventional hardware, for example an entity such as a smartphone or tablet, which are usually equipped with a camera. A higher degree of flexibility is also achieved as a result. Recordings for the live transmission can be considerably simplified.

In addition, the method according to the present disclosure can be implemented very cost-effectively. Thus, for example, the setting up and equipping of a studio for live transmission is no longer necessary.

Compared to the recording in a studio, the amounts of data to be processed or the outlay, respectively, for generating a realistic reproduction can also be reduced. As a rule, it is only necessary to adapt the virtual object to the ambient conditions, which is particularly advantageous in the case of live transmission in real time. Finally, the hardware requirements are likewise reduced in this way, which makes it possible to resort to conventional hardware such as a tablet or smartphone during the execution of the method.

Realistic video streams can be generated using the method according to the present disclosure; in general, it is only necessary to adapt the virtual object to the otherwise real scenery.

According to a highly expedient aspect, the method according to the present disclosure is carried out by a smartphone or a tablet, for example by the processor of a smartphone or tablet.

According to the method according to the present disclosure, a video stream with a multiplicity of real surrounding images is received by the processor. The video stream with the real surrounding images can be recorded using an image capturing unit such as a camera and sent to the processor. The real surrounding images can be received by the processor directly in real time or nearly real time, respectively, by the image capturing device. For example, the plurality of real surrounding images of the video stream can be received at consecutive points in time, in some cases at a frame rate of 30 to 120 frames/second or as a bundle of a plurality of real surrounding images.

Furthermore, the processor receives raw data relating to the virtual object. The raw data comprise in some cases the basic geometric structure of the virtual object. The raw data relating to a virtual object can be stored, for example, on an external server and received by the processor from this server. In some suitable embodiments, the raw data can be received from the external server at an entity, such as a smartphone or tablet, and can be stored on a memory of the entity. The processor is expediently in communication connection with the memory and can retrieve the raw data stored therein from the memory. Thus, the raw data can be received by the processor from the external server via a memory. In other words, the raw data can be retrieved by the processor from a memory which is in some cases part of the same entity as the processor. Thus, the method according to the present disclosure can furthermore comprise receiving the raw data from a memory which is in some cases part of the same entity as the processor and in some other cases the image capturing device. In this expedient embodiment, the processor does not require a standing connection to an external server. The raw data can be stored, for example, in advance on the memory of the entity.

For a real surrounding image, the processor generates rendering data for the virtual object in a highly suitable embodiment of the method according to the present disclosure. Rendering data comprise in some cases a texture of the virtual object, such as, for example, shading, coloring and/or, in some cases and, brightness. Based on the raw data and the rendering data, the processor generates a rendered virtual object. During the rendering, for example, the geometric structure from the raw data is provided with the texture from the rendering data and a rendered virtual object is generated therefrom. The rendered virtual object is subsequently inserted into the real surrounding image. The insertion can be effected, for example, by replacing the pixels in the real surrounding image with corresponding pixels of the rendered virtual object. Thus, the virtual object can be fitted into the real surrounding image as realistically as possible taking into account the conditions, such as, for example, the light conditions or the geometric conditions, in the real surrounding image. A rendered image within the meaning of this application is thus a real surrounding image into which a rendered virtual object has been inserted.

The rendered image comprising the real surrounding image into which the rendered virtual object has been inserted is output by the processor in a rendered video stream comprising a plurality of rendered images. A rendered video stream within the meaning of this application is thus a video stream comprising a plurality of rendered images. The rendered video stream can be output, for example, to a transmission center. In some highly suitable embodiments, the rendered video stream can be output by the processor via an NDI (network device interface) interface or an NDI connection, respectively. An NDI connection makes high data transmission rates possible, which ensures the lowest possible latencies in the transmission of the rendered video stream. Such a transmission is highly advantageous for live applications. The rendered video stream can also be sent from the processor to the control unit via a local environment, such as a in some cases local wireless LAN connection or a Bluetooth connection.

The output of the rendered images is effected in some cases directly, in some cases in real time or in nearly real time. The rendered images in the rendered video stream are in some cases output at consecutive points in time, in some cases at a frame rate of 30 to 120 frames/second.

In some suitable embodiments, in order to implement a live transmission, which is as latency-free as possible, a time period of approximately 150 ms to 400 ms lies between the receiving of the first real surrounding image in the video stream and the outputting of the resulting rendered first image in the rendered video stream.

The generation of rendering data, the rendering of the at least one virtual object and the generating of a rendered first image can be repeated for one or more, in some cases each, real surrounding image in the video stream. Thus, one or more, in some cases each, of the real surrounding images can be converted into a respective rendered image.

Using the method according to the present disclosure, a video stream with real surrounding images can thus be recorded on site in a live transmission, and any desired virtual objects can be realistically inserted into the real surrounding images of the video stream. Thus, a rendered video stream can be generated for a live transmission, in the individual images of which a virtual object is projected into a real surrounding.

In addition, further expedient aspects of the method according to the present disclosure are provided.

According to one aspect, the generation of rendering data comprises receiving, from a control unit, first instructions for generating the rendering data, and generating the rendering data based on these first instructions. The instructions can be received, for example, via a TCP/IP connection or a WiFi connection.

Thus, the rendering data, in some cases the texture of the virtual object, can be adapted in the rendered video stream via the control unit. The control unit can have, for example, an interface, such as a touchscreen, which is adapted to receive an input for modifying the virtual object. The control unit can generate instructions for generating the rendering data based on the input. The instructions comprise in some cases information about the texture of the virtual object.

With the method according to the present disclosure, in an expedient embodiment, a possibility is also created for influencing the rendering of the virtual object on the processor by way of the control unit. In some cases, a possibility can thus be created in which a user can intervene in the rendering of the virtual object and can control it in order to implement a representation of the virtual object in the real surrounding image that is as realistic as possible. In one embodiment, the rendering of the virtual object can thus be influenced in the rendered video stream, in some cases also during the live transmission. In this way, a reproduction that is as realistic as possible can be implemented during the live transmission. The instructions can be based, for example, on a user input. However, it is also conceivable for the instructions to be generated by a measurement of the ambient conditions in the real surrounding.

In a further highly suitable aspect, the method according to the present disclosure further comprises the following steps performed by the processor: outputting a preview of the rendered first image to the control unit; receiving, from the control unit, second instructions for rendering the at least one virtual object in response to the output of the preview; for a second surrounding image of the multiplicity of surrounding images following the first real surrounding image in the video stream: generating second rendering data for the at least one virtual object based on the second instructions, rendering the at least one virtual object based on the raw data and the second rendering data, and generating a rendered second image by inserting the at least one rendered virtual object into the second real surrounding image; and outputting the rendered second image after the rendered first image in the rendered video stream. The communication from the processor with the control unit can be effected wirelessly or by wire, in some cases via a TCP/IP connection or a WiFi connection. In this way, a possibility can be created for a user to influence the rendering, in some cases the texture of the rendered virtual object, during the live transmission, such that the virtual object can be fitted into the ambient conditions realistically even in the case of changing ambient conditions in the real surrounding images. By way of the preview of the rendered first image, a possibility can in some cases also be created for verifying the reproduction of the virtual object. Thus, in response to the output of the preview, instructions can be received on the basis of which the rendering of the virtual object can be adapted in the second surrounding image following the first real surrounding image. The rendering of the virtual object can thus be influenced during the live transmission in the rendered video stream. In this way, a reproduction that is as realistic as possible can be implemented during the live transmission. The control unit can in some cases comprise a display unit. In some embodiments, the display unit can be a touchscreen. In other embodiments, an input means can be provided in the control unit in order to influence the rendering of the virtual object.

In a further advantageous aspect, the preview has a reduced resolution compared to the first rendered image. As a result, the amount of data sent between the processor and the control unit can be reduced. As a result, the requirements for the bandwidth and the hardware can be reduced. In this way, fast processing times are also possible, which is highly advantageous for the live transmission.

In a further expedient aspect, the method further comprises the following steps performed by the processor: receiving, from the control unit, position information for positioning the virtual object in the first real surrounding image and/or the second real surrounding image, and inserting the at least one rendered virtual object at a position specified by the position information in the first and/or the second real surrounding image. The position information can in some cases be generated by the control unit on the basis of an input by a user at the control unit. With this embodiment of the method according to the present disclosure, the position of the object in the surrounding images can be specified. For example, a user can specify using the control unit at which point in the surrounding image the virtual object is inserted. In some cases, the processor is adapted to adapt the position of the virtual object in one or more surrounding images on the basis of, in some cases specifiable, characteristic features in the one or more surrounding images.

In a further advantageous aspect, the first and/or second instructions are based on an input at the control unit. In this way, a possibility can be created that a user can influence the rendering of the virtual object in the rendered video stream, in some cases during the live transmission.

According to a further advantageous aspect, the first and/or second instructions can be received from the control unit wirelessly or by wire, in some cases via a TCP/IP connection or a WiFi connection, and in some cases the preview can be output to the control unit wirelessly or by wire, for example via the TCP/IP connection or the WiFi connection.

The control unit and the processor can be part of separate entities, for example, which are in communication connection with one another, wherein in some cases an image capturing device and the processor are an integral part of the same entity, such as a smartphone or tablet, for example. Thus, the rendered images can be checked by a user and the rendering can be adapted, if necessary, while another user can concentrate on the recording of the real surrounding images. A connection via a TCP/IP connection or a WiFi connection can be implemented very efficiently, since existing infrastructure can be resorted to, in some cases by way of a local network.

According to a further advantageous aspect, the video stream with the multiplicity of real surrounding images can be received, in some cases directly, by an image capturing device. An image capturing device is a device which is adapted to record the video stream. By the video stream being received directly by the image capturing device, latency times can be shortened, which is highly advantageous in the implementation of a live transmission. It is thus possible for the images to be able to be received in real time or nearly real time by the processor. The image capturing device and the processor can be part of the same entity, for example, as in a smartphone or tablet.

According to a further advantageous aspect, the rendering data comprise shading, brightness, resolution and/or, in some cases and, coloring of the virtual object. In addition, the rendering data can, alternatively or additionally, comprise information about a perspective and/or size of a representation of the virtual object. In some cases, the texture of the virtual object can be determined by the rendering data.

According to a further advantageous aspect, the rendered video stream can be output to an external entity, in some cases to a transmission center, in some cases via the control unit or directly to the external unit, wherein in some cases the rendered video stream is output via an NDI connection. In a further advantageous aspect, the rendered video stream can be output by broadcasting, in some cases using the NDI connection. Thus, an NDI-capable unit can receive the rendered video stream. In some highly expedient aspects, the rendered video stream is output via the control unit to the transmission center, wherein the rendered video stream is output by the processor via an NDI connection to the control unit. The control unit can act as an intermediary between the processor and the control center, for example. In some expedient embodiments, the rendered video stream can comprise information which prompts the control unit to forward the rendered video stream to the transmission center. An NDI interface is usually advantageous for live applications. An NDI interface makes possible a transmission of larger amounts of data such as the rendered video stream that is as latency-free as possible. In further advantageous embodiments, however, the rendered video stream can also be sent from the processor to the control unit via a local environment, such as a in some cases local wireless LAN connection or a Bluetooth connection. In further advantageous aspects, it can also be provided that the rendered video stream is output to an internal memory. The internal memory can in some cases be part of the same entity as the processor, as is usually the case with a smartphone or tablet, for example. In further advantageous embodiments, however, the internal memory can also be in communication connection with the entity of the processor. By outputting and storing the rendered video stream on an internal memory, an offline operation can be set up. For example, the rendered video stream can then be transmitted to the external unit at a later point in time after the generation.

According to a further advantageous aspect, the method according to the present disclosure also comprises the following steps performed by the control unit: receiving, from the processor, the rendered video stream, in some cases via an NDI interface; and forwarding the rendered video stream to a transmission center. The method can thus be carried out very flexibly in the field. The control unit can be an intermediary between the processor and the transmission center, for example. The control unit can be in communication connection with the transmission center, for example wirelessly or by wire. In other examples, the control unit can act as a hub for a plurality of processors, which are each part of separate entities. Offline can mean, for example, that there is no connection to the Internet. In other examples, the rendered video stream can be sent from the processor to the control unit via a local environment, such as a in some cases local wireless LAN connection or a Bluetooth connection.

According to a further advantageous aspect, the control unit and the processor are an integral part of an entity, wherein in some cases the processor and the image capturing device are part of the same entity, such as a smartphone or tablet, for example.

Thus, in an advantageous embodiment, both the processor and the control unit and the image capturing device can be part of an entity. The corresponding entity can be a smartphone or tablet, for example. An advantage according to this aspect is that an individual user can record the surrounding images and at the same time adjust the rendering of the virtual object in the rendered video stream. A very flexible possibility is thus created for recording a rendered video stream on site for a live transmission.

According to a further advantageous aspect, the control unit and the processor are part of separate entities, wherein in some cases the processor and the image capturing device are part of the same entity. For example, the processor and the image capturing device can be part of a smartphone or tablet, wherein the control unit is a separate computer which is in communication connection with the tablet or the computer.

The processor and in some cases the image capturing device can thus be part of an entity, such as a smartphone or tablet, for example, and the control unit is part of a separate entity which is in communication connection with the smartphone, such as a separate computer, for example. The control unit and the processor can in some cases communicate with one another via a TCP/IP connection or a WiFi connection. In this way, a possibility can be created for recording the rendered video stream on site by a user, wherein a check and, if necessary a correction of the rendering of the virtual object can be carried out by a further user. The one user can thus focus on the recording of the real surrounding images, while the further user can concentrate on the rendering. A possibility is thus created for generating rendered video streams that are as high-quality as possible.

Furthermore, the method according to the present disclosure can advantageously likewise comprise the steps carried out at the control unit.

According to a further advantageous aspect, the method according to the present disclosure can further comprise the following steps performed by the control unit: receiving a preview of the first rendered image from the processor; replaying the preview using a display; receiving an input for adjusting the rendering of the virtual object based on the replay of the preview; generating instructions for rendering the at least one virtual object based on the input; and sending the instructions to the processor. In this way, a user can be enabled to check the rendering of the virtual object on the basis of the preview and to verify whether the rendering of the virtual object is realistic compared to the surrounding image. Furthermore, a user is offered the possibility of manually adjusting the rendering of the virtual object. Thus, a representation of the virtual object in the rendered video stream that is as realistic as possible can be generated.

Furthermore, according to a further aspect of the present disclosure, a device, in some cases a processor, is provided for generating a rendered video stream, in some cases for a live transmission, wherein the device is adapted and arranged to carry out the method steps according to the above-described method according to the present disclosure.

Furthermore, according to a further aspect of the present disclosure, a computer program product is provided comprising instructions which, when the program is executed by a data processing device, in some cases the above device according to the present disclosure, cause the device to carry out the method steps according to the described method according to the present disclosure.

In addition, according to a further aspect of the present disclosure, a computer-readable storage medium is provided comprising instructions which, when executed by a computer, cause the computer to carry out the steps of the method according to the present disclosure.

Furthermore, according to a further aspect of the present disclosure, a system is provided for generating a rendered video stream, in some cases for a live transmission, comprising: the above device according to the present disclosure, in some cases the processor, a control unit in communication connection, in some cases wired or wireless, in some cases via a TCP/IP connection or a WiFi connection, with the device according to the present disclosure, wherein the control unit is in some cases adapted to carry out the preceding method steps of the control unit. The communication connection between processor and control unit can alternatively also be formed by a local environment, such as a wireless LAN connection or a Bluetooth connection. The corresponding connection can be established by the processor and/or the control unit, for example.

The system according to the present disclosure allows a rendered video stream to be generated very flexibly. In some cases, the video stream can be recorded in the field and in some cases modified by a user. A possibility is thus created that a user records a rendered video stream, for example via a smartphone or a tablet, which is forwarded for further transmission, in some cases live transmission. The same or a further user can check the representation of the virtual object in the real surrounding image in the live transmission and, if necessary, adjust it.

In some further advantageous aspects, the control unit can be adapted to receive the rendered video stream from the device according to the present disclosure and forward it to a transmission center. The method according to the present disclosure can thus be used very flexibly.

In other advantageous aspects, the rendered video stream can be output by way of broadcasting, in some cases using an NDI connection. In this way, a corresponding external unit set up for the reception can receive the rendered video stream.

In some further advantageous aspects, the system according to the present disclosure comprises an image capturing unit in communication connection with the device according to the present disclosure, wherein the image capturing unit is adapted to record the video stream and in some cases send it directly to the device according to the present disclosure.

The method according to the present disclosure can be performed by the system according to the present disclosure, so that the object mentioned at the outset is achieved and the mentioned advantages are achieved.

In a further advantageous aspect, the image capturing device and the device are an integral part of the same entity. The entity can be a smartphone or tablet, for example. An arrangement is thus provided which makes possible a very flexible recording of a rendered video stream with a virtual object on site.

According to a further advantageous aspect, the device according to the present disclosure and the control unit can be an integral part of an entity. In this way, a possibility can be created such that a user records a rendered video stream, for example via a smartphone or a tablet, which is forwarded for further live transmission, while the same user can check and adjust the representation of the virtual object in the real surrounding image in the live transmission.

According to a further advantageous aspect, the device according to the present disclosure and the control unit are part of separate entities. In this way, a possibility can be created such that a user records a rendered video stream, for example via a smartphone or a tablet, which is forwarded for further live transmission, while a further user can check and adjust the representation of the virtual object in the real surrounding image in the live transmission.

The present disclosure is based on the surprising finding that outdoor video recordings can also be implemented in a highly professional manner in a technically uncomplicated manner with incorporation of augmented reality graphics and/or 3D elements, specifically also in the case of live transmissions. Surprisingly, this is achieved with relatively small-sized and light equipment, which can easily also be taken to more remote locations. Furthermore, it has surprisingly been found that the method according to the present disclosure as well as the device according to the present disclosure and the system according to the present disclosure make possible a very short set-up time such that entirely new application possibilities become possible, in some cases for spontaneous live reporting. This permits a very flexible and additionally cost-effective use without losses having to be accepted with regard to the requirement to make possible highly modern television reproductions. In addition, it has surprisingly been shown that the method according to the present disclosure as well as the device according to the present disclosure or the system according to the present disclosure, respectively, can also be operated by only a single person, wherein in general a team of two persons is completely sufficient even for complex recording situations, a so-called cameraman and an operator who controls the rendered contents, which are to be integrated into the recording.

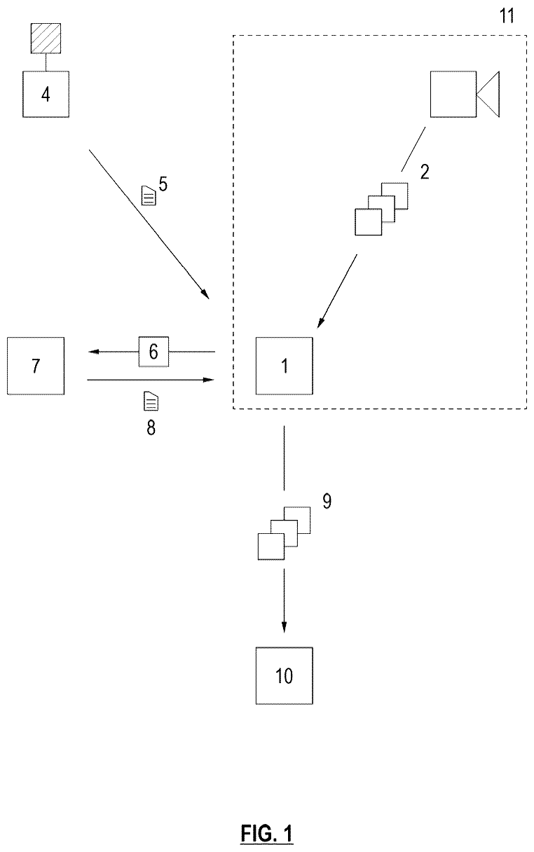

FIG. 1 shows by way of example a system according to the present disclosure for generating a rendered video stream, in some cases for a live transmission.

In the embodiment shown in FIG. 1, the system according to the present disclosure comprises a processor 1, an image capturing device 3, a server 4, a control unit 7 and a transmission center 10. The processor 1 forms the core of the system and generates a rendered video stream with a corresponding multiplicity of consecutive rendered images 9 from a video stream recorded using the image capturing unit 3 with a multiplicity of consecutive real surrounding images 2. The rendered video stream is output by the processor 1 in real time to the transmission center 10.

The video stream with the multiplicity of real surrounding images 2 is recorded by an image capturing device 3 and is in some cases sent directly to the processor 1. The video stream comprises a multiplicity of real surrounding images 2, recorded at consecutive points in time, of the surrounding of the image capturing device 3. The real surrounding images 2 thus depict a real surrounding. The real surrounding images 2 of the video stream are in some cases sent to the processor 1 consecutively according to the recording time of the respective surrounding images 2 or in groups depending on the buffer memory provided and the available bandwidth. The processor 1 receives the video stream 2 in real time or nearly real time, respectively, from the image capturing device 3.

Furthermore, the processor 1 receives raw data 5 relating to a virtual object 12 from an external server 4. In general, raw data 5 of one or more virtual objects 12 are stored on the server 4. The raw data in some cases form a geometric basic framework for the corresponding virtual object 12. The raw data 5 can be stored on a volatile or nonvolatile memory in connection with the processor 1, so that the processor 1 can retrieve them.

For a first real surrounding image 2 of the video stream received by the image capturing unit 3, the processor 1 generates rendering data for rendering the virtual object 12. The rendering data comprise a texture, such as shading, coloring and/or brightness of the virtual object. In addition, the rendering data can comprise an orientation and/or position and/or size of the virtual object. The rendering data can be initially generated by the processor 1 on the basis of an evaluation of parameters of the first real surrounding image 2 or of a plurality of real surrounding images 2.

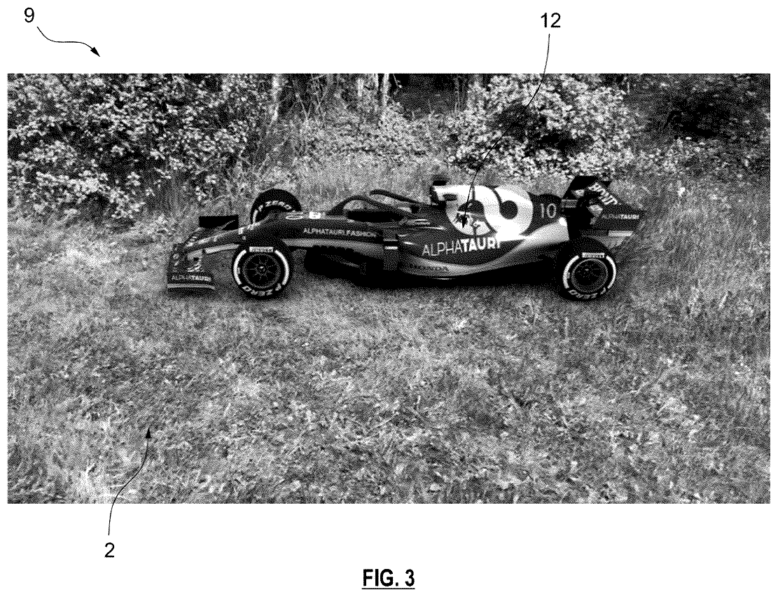

Based on the raw data 5 and the rendering data, the processor 1 generates a rendered virtual object 12 which is adapted to the first real surrounding image 2. Furthermore, the processor 1 inserts the rendered virtual object 12 into the real surrounding image 2 and thus generates a rendered image 9 from the first real surrounding image 2 and the virtual object 12. In the rendered image 9, the rendered virtual object 12 is imaged in the surrounding of the real surrounding image 2, as shown in FIG. 3.

The rendered image 9 is output in the rendered video stream to the transmission center 10 in some cases in real time or nearly real time, respectively. For this purpose, the rendered video stream can be output via an NDI connection. However, the rendered video stream 9 can also be output to any desired other external unit. It is also conceivable that the rendered video stream 9 can be output by broadcasting, in some cases by way of NDI, so that an external unit set up for this purpose, such as the transmission center 10, can receive the rendered video stream 9.

In addition, the processor 1 sends a preview 6 of the rendered image 9 to the control unit 7. The control unit 7 and the processor 1 communicate wirelessly or by wire, in some cases via TCP/IP connection or via a wireless LAN connection. The control unit 7 has, for example, a display unit by way of which the preview 6 is displayed. The control unit 7 is set up in such a way that a user interface can furthermore be displayed via the display unit. The user interface can comprise various setting parameters by way of which the rendering, i.e., the texture, but also the position and/or orientation and/or size of the rendered virtual object 12 in the real surrounding image can be adapted. Furthermore, the control unit 7 is set up to receive an input for adjusting the texture, the position and/or orientation and/or size of the virtual object 12. The control unit 7 is set up to generate, in response to a corresponding input, instructions 8 for adjusting the texture, the position and/or orientation and/or size of the rendered virtual object 1. The control unit 7 sends the instructions 8 to the processor 1. The instructions 8 contain information for the processor 1 for adapting the rendering data with regard to the texture and/or the position and/or orientation and/or size of the rendered virtual object 12.

For a second real surrounding image 2, which follows the first real surrounding image 2 in the video stream, the processor 1 generates second rendering data for rendering the virtual object 12 based on the received instructions 8. Based on the raw data 5 and the second rendering data, the processor 1 generates a rendered virtual object 12 and inserts the rendered virtual object 12 into the second real surrounding image 2. By inserting the rendered virtual object 12 into the second real surrounding image 2, the processor 1 generates a rendered second image 9, which is output in the rendered video stream 9 following the rendered first image to the transmission center 10.

A user is thus offered the possibility of adjusting the rendering of the virtual object 12 in the rendered video stream during the ongoing live transmission. In this respect, a representation of the virtual object 12 in the rendered video stream 12 that is as realistic as possible can be achieved. The procedure can be repeated for a multiplicity of received real surrounding images 2 in the video stream during the live transmission.

In the embodiment shown in FIG. 1, the image capturing device 3 and the processor 1 are part of an entity 11, such as a smartphone or a tablet, for example. The control unit 7 is separate from the entity 11 and communicates wirelessly or by wire, for example via TCP/IP connection or via a wireless LAN connection, with the entity 11 or the processor 1, respectively. A user can thus film the surrounding using the smartphone or the tablet, wherein the rendered video stream is generated based on the video stream thus generated with the multiplicity of real surrounding images 2. A further user can assess and adjust the rendering of the virtual object 12 in parallel therewith. The further user can thus direct the attention to the generation of a realistic rendered video stream.

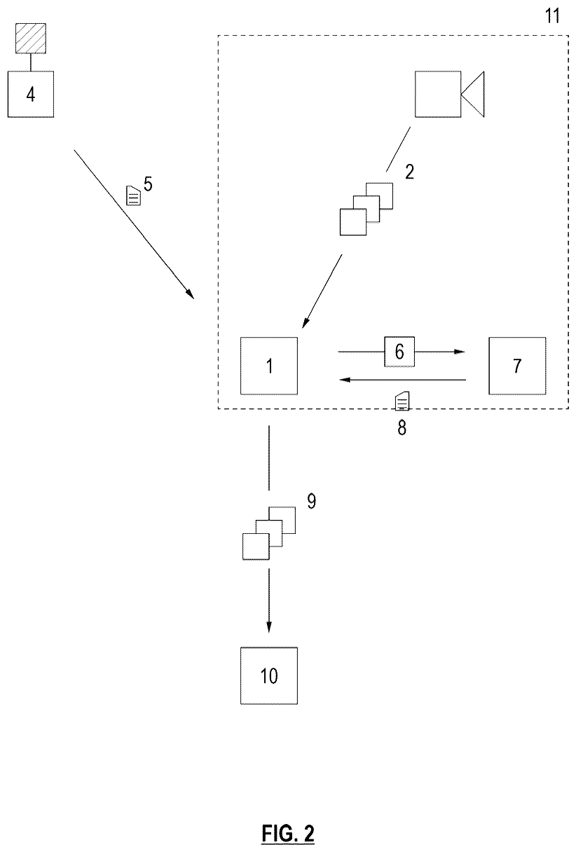

FIG. 2 shows a further embodiment of the system for generating a rendered video stream, in some cases for a live transmission. The system shown in FIG. 2 is based here on the system shown and described in FIG. 1.

In contrast to the embodiment shown in FIG. 1, the processor 1, the image capturing device 3 and the control unit 7 are an integral part of the same entity 11, such as a smartphone or a tablet, for example. The recording of the video stream 2 with the multiplicity of real surrounding images 2 and the checking and adjustment of the rendering can thus be carried out on site by an individual user. In this example, the processor 1 and the control unit 7 communicate by wire.

FIG. 3 shows by way of example a rendered image 9 in the rendered video stream. A rendered virtual object 12 in the form of a racing car which has been inserted into a real surrounding image 2 of the video stream can be identified in the rendered image 9. As can be seen, the rendering of the virtual object 12 is adapted to the ambient conditions, such as, for example, the illumination, in the real surrounding image 2. A preview 6 of the corresponding rendered image 9 can be displayed to a user via the control unit 7. Based on the preview 6, a user can assess whether a realistic reproduction of the virtual object 12 in accordance with the real surrounding image 2 is achieved. The user is offered the possibility of manually adjusting the rendering of the virtual object 12 in the rendered video stream during the live transmission and of obtaining a reproduction of the rendered virtual object 12 in the rendered video stream that is as realistic as possible.

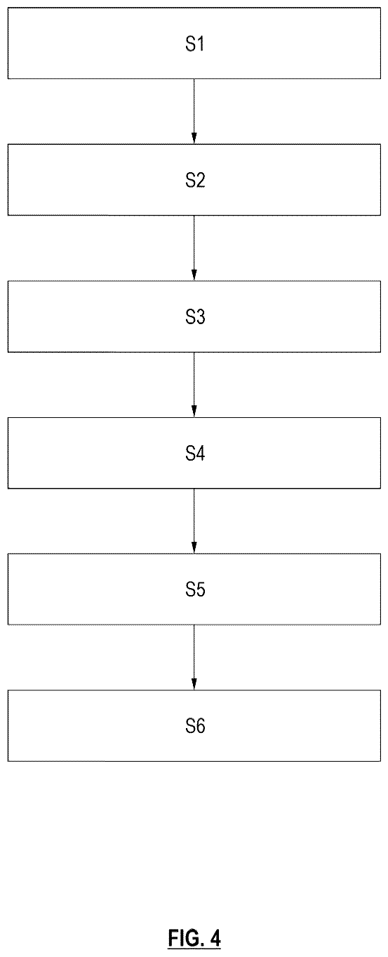

FIG. 4 shows a sequence of the steps of an expedient embodiment of the method according to the present disclosure for generating a rendered video stream for a live transmission. Step 1 (S1) comprises receiving a video stream with a multiplicity of real surrounding images 2. Step 2 (S2) comprises receiving raw data 5 from at least one virtual object 12. Step 3 (S3) comprises generating rendering data for the at least one virtual object 12 for a first real surrounding image 2 of the multiplicity of real surrounding images 2. Step 4 (S4) comprises rendering the at least one virtual object 12 based on the raw data 5 and the rendering data, and step 5 (S5) comprises generating a rendered first image 9 by inserting the at least one rendered virtual object 12 into the first real surrounding image 2. Step 6 (S6) comprises outputting the rendered first image 9 in the rendered video stream comprising a plurality of rendered images 9.

Furthermore, it can also be provided in a step 7: outputting a preview 6 of the rendered first image 9 to the control unit 10. A step 8 can comprise receiving, from the control unit 10, instructions 8 for rendering the at least one virtual object 12 in response to the output of the preview 6. A step 9 can comprise generating rendering data for the at least one virtual object 12 based on the instructions 8 for a second real surrounding image 2 of the plurality of real surrounding images 2 following the first real surrounding image 2 in the video stream. A step 10 can comprise rendering the at least one virtual object 12 based on the raw data 5 and the second rendering data. A step 11 can comprise generating a rendered second image 9 by inserting the at least one rendered virtual object 12 into the second real surrounding image 2. A step 12 can comprise outputting the rendered second image 9 after the rendered first image 9 in the rendered video stream.

The features of the present disclosure disclosed in the above description, in the claims and in the drawings can be essential both individually and in any desired combination for the realization of the present disclosure in its various embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

### REFERENCES

1 processor
2 real surrounding image
3 image capturing device
4 server
5 raw data
6 preview
7 control unit
8 instructions
9 rendered surrounding image
10 transmission center
11 entity
12 virtual object
S1-S6 method steps

1. A method for generating a rendered video stream, comprising:
by a processor:
receiving a video stream with a plurality of real surrounding images;
receiving raw data relating to at least one virtual object;
for a first real surrounding image of the plurality of real surrounding images:
generating rendering data for the at least one virtual object,
rendering the at least one virtual object based on the raw data and the rendering data, and
generating a rendered first image by inserting the at least one rendered virtual object into the first real surrounding image; and
outputting the rendered first image in the rendered video stream comprising a plurality of rendered images.

2. The method according to claim 1, wherein the generation of rendering data comprises:
receiving, from a control unit, first instructions for generating the rendering data, and
generating the rendering data based on the first instructions.

3. The method according to claim 2, further comprising:
by the processor:
outputting a preview of the rendered first image to the control unit;
receiving, from the control unit, second instructions for rendering the at least one virtual object in response to the output of the preview,
for a second real surrounding image of the plurality of real surrounding images following the first real surrounding image in the video stream:
generating second rendering data for the at least one virtual object based on the second instructions,
rendering the at least one virtual object based on the raw data and the second rendering data, and
generating a rendered second image by inserting the at least one rendered virtual object into the second real surrounding image; and
outputting the rendered second image after the rendered first image in the rendered video stream.

4. The method according to claim 3, further comprising:
by the processor:
receiving, from the control unit, position information for positioning the virtual object in the first real surrounding image and/or the second real surrounding image, and
inserting the at least one rendered virtual object at a position specified by the position information in the first and/or the second real surrounding image.

5. The method according to claim 3, wherein the first and/or second instructions are based on an input at the control unit.

6. The method according to claim 3, wherein the first and/or second instructions are received from the control unit wirelessly or by wire.

7. The method according to claim 1, wherein the rendered video stream is output to an external unit.

8. The method according to claim 2, further comprising:
by the control unit:
receiving, from the processor, the rendered video stream; and
forwarding the rendered video stream to a transmission center.

9. The method according to claim 2, wherein the control unit and the processor are an integral part of an entity, or the control unit and the processor are part of separate entities.

10. The method according to claim 3, further comprising:
by the control unit:
receiving the preview of the first rendered image from the processor;
replaying the preview using a display;
receiving an input for adjusting the rendering data of the virtual object in response to the replay of the preview;
generating instructions for rendering the at least one virtual object based on the input; and
sending the instructions to the processor.

11. A device for generating a rendered video stream, wherein the device is adapted and arranged to carry out the method according to claim 1.

12. The device according to claim 11, further comprising a computer program product comprising instructions which, when the program is executed by a data processing device, cause the device to carry out the method.

13. A non-transitory computer-readable storage medium comprising executable instructions which, when executed by a computer, cause the computer to carry out the method according to claim 1.

14. A system for generating a rendered video stream, the system comprising:
the device according to claim 11,
a control unit in communication connection with the device.

15. The system according to claim 14, wherein the control unit is adapted to receive the rendered video stream from the device and forward it to a transmission center.

16. The system according to claim 14, wherein the device and the control unit are an integral part of an entity.

17. The system according to claim 14, wherein the device and the control unit are separate entities.

18. The method according to claim 1, wherein the video stream is a live transmission.

19. The method according to claim 6, wherein the first and/or second instructions are received from the control unit via a TCP/IP connection or a WiFi connection.

20. The method according to claim 6, wherein the preview is output to the control unit wirelessly or by wire.

21. The method according to claim 20, wherein the preview is output to the control unit via a TCP/IP connection or a WiFi connection.

22. The method according to claim 7, wherein the external unit is a transmission center.

23. The method according to claim 7, wherein the rendered video stream is output via a control unit or directly to the external unit.

24. The method according to claim 7, wherein the rendered video stream is output via an NDI connection.

25. The method according to claim 9, wherein the video stream is captured by an image capturing device, and wherein the processor and the image capturing device are part of the same entity.

26. The device according to claim 11, wherein the device is a processor.
